(19) United States
(12) Patent Application Publication
(10) Pub. No.: US 2016/0217663 A1
(43) Pub. Date: Jul. 28, 2016

(54) SYSTEM FOR MOVABLE GATE BETWEEN CLOSED AND OPENED POSITIONS

(71) Applicant: OPTEX CO., LTD., Shiga (JP)

(72) Inventors: Tokio SHICHIRI, Otsu-shi (JP); Masanao SHIRAISHI, Otsu-shi (JP); Takaki IMAI, Otsu-shi (JP); Taro MINOIKE, Otsu-shi (JP)

(73) Assignee: OPTEX CO., LTD., Shiga (JP)

(21) Appl. No.: 14/929,917

(22) Filed: Nov. 2, 2015

(30) Foreign Application Priority Data
Jan. 26, 2015 (JP) 2015-012012

(51) Int. Cl. G08B 13/08

(52) U.S. Cl. CPC G08B 13/08

(57) ABSTRACT

A device for determining an alert condition in a system for a gate which device is usable easily in any building and is suitable for a building whose security is not strict, is provided. The system 1 includes: an access device 4, a gate 2 being opened or opening of the gate 2 being permitted at least after the access device 4 is accessed; a full closing detector 3 detecting full closing of the gate 2; an object detector 5 including at least one sensor 5a or 5b detecting an object in a detection area 50a or 50b which is near the gate 2 and within at least one of two zones B and C; and the device 6. The device 6 is connected to the detectors 3 and 5, and determines the alert condition after a predetermined combination of full-closing detection or non-detection and object detection or non-detection occurs.

### CROSS REFERENCE TO THE RELATED APPLICATION

This application is based on and claims Convention priority to Japanese patent application No. 2015-012012, filed Jan. 26, 2015, the entire of which is herein incorporated by reference as a part of this application.

### BACKGROUND OF THE INVENTION

1. Field of the Invention

The present invention relates to a system for an opening/closing body or a gate such as a door or a shutter, which is movable between closed and opened positions.

2. Description of Related Art

In recent years, at the entrance of a building such as a condominium, an access control system is used. Thus, only a person having authority is permitted to enter the building. However, so-called tailgating, which is that when a person having authority is authenticated and a door of a condominium is opened, an unauthorized person would follow the person to slip into the building, has become a problem.

In order to solve the tailgating problem, in JP Laid-Open Patent Publication No. 2008-134729, the number of passers counted based on a captured image is compared with the number of times of authenticating a person having authority by an authentication device, and if these numbers do not coincide with each other, the tailgating is detected.

In addition, JP Laid-Open Patent Publication No. 2008-134729 also describes access control using an interlock chamber provided between two doors. This ensures a state where only a person having authority is present in the interlock chamber, thereby assuredly preventing tailgating.

### DISCLOSURE OF THE INVENTION

However, in the method described in the above publication, an imaging device is required to count the number of passers. In addition, not all buildings can provide the interlock chamber between the two doors due to its structure. Also in the method described in the above publication, all passers other than people having authority are determined as the passers to be refused. As such, with the access control system using the interlock chamber, passing of people other than people having authority is not permitted at all. Thus, in the case where the access control described in the above publication is applied to a building whose security is not strict, such as a condominium, even when a resident's friend is about to enter the condominium together with a resident in the condominium, this is also determined as tailgating, so that the access control works excessively strictly.

Therefore, an object of the present invention is to provide a device for determining an alert condition derived from a state of a gate, which device has a configuration usable easily in any building and is suitable for judging an alert condition in a building whose security is not strict.

In order to achieve the above-described object, a device for determining an alert condition derived from a state of a gate provided between two zones and movable between a closed position and an opened position according to one aspect of the present invention is included in a system for the gate. The system includes: an access device accessed by an object which tries to enter a predetermined one or either one of the two zones, the gate being moved to the opened position or moving the gate to the opened position being permitted at least after the access device is accessed; a full closing detection device configured to detect full closing of the gate, in which the gate is in the closed position; an object detection device including at least one object detection sensor configured to detect an object in a detection area which is near or adjacent to the gate and within at least one of the two zones; and the device for determining the alert condition. The device for determining the alert condition is configured to be connected to the full closing detection device and the object detection device, and includes an alert condition determination module configured to determine the alert condition after a predetermined combination of: full-closing detection or non-detection by the full closing detection device; and object detection or non-detection by the object detection device occurs.

The “system for the gate” described above refers to a system which may include one or more devices associated with an operation of the gate, thereby judging an alert condition in connection with the gate.

In addition, the phrase “determine an alert condition derived from a state of a gate” may mean to determine, for example, an alert condition with opening of the gate, and/or an alter condition with the gate being closed. The gate is moved to the opened position or moving the gate to the opened positioning is permitted at least after the access device is accessed, where the possibility of an alert condition, that is, a state where watch is required, is raised.

Moreover, the phrase “connected to the full closing detection device and the object detection device” may include not only connection by a wire but also the case where transmission/reception of data is enabled by means of radio. That is, “connected” may mean that transmission/reception of signals is enabled.

Furthermore, the phrase “accessed by an object” is not limited to only the case where an object (human body) inputs an identification number or carries out an action for authentication by means of an IC card or the like. For example, the case where an object (human body) enters a predetermined area or a button is merely pressed may also be included.

According to this configuration, regarding the gate with which the access device is associated, a situation which occurs or can occur around the gate can be inferred based on at least detection of full closing and detection of an object. Thus, it is possible to infer unauthorized entry or unauthorized stay or that a current state is a dangerous state. However, since a situation is merely inferred, this configuration is suitable for determining an alert condition in a building whose security is not strict, or the like. Meanwhile, determination of an alert condition can be achieved with a simple configuration of detection or non-detection of full closing and detection or non-detection of an object.

In a preferred embodiment, the two zones include a first zone to which entry is restricted and which the object tries to enter, and a second zone, respectively, the access device includes an authentication device configured to determine whether the object which tries to enter the first zone has authority, and only when the authentication device determines that the object has authority, the gate is moved to the opened position or moving the gate to the opened position is permitted. According to this configuration, in access control in which authentication is required for entry to the first zone, unauthorized entry to the first zone to which entry is restricted can be handled by using inference of a current situation around the gate.

Here, entry to the second zone may be or may not be restricted.

Preferably, whereas the first zone is a restricted zone, the second zone is a non-restricted zone to which entry is not restricted. Alternatively, whereas the first zone may be a restricted zone, the second zone may be also a restricted zone to which entry is restricted, and restriction of entry to the first zone may be stricter than restriction of entry to the second zone.

In a preferred embodiment, the object detection device includes two object detection sensors configured to detect objects in two detection areas which are near the gate and within the two zones, respectively.

In a further preferred embodiment, the predetermined combination is that the gate is not in the closed position and no object is detected within any of the two detection areas, and after the combination occurs, if an object which does not have authority is detected in the detection area within the second zone and then an object is detected in the detection area within the first zone, the alert condition determination module infers unauthorized entry, thereby judging the alert condition.

Here, while the gate is not in the closed position, there is a possibility that a person who does not have authority can enter. Based on this, it is also thought that after a state of being not fully closed, if an object is detected in the detection area within the second zone and then detected in the detection area within the first zone, it is determined that a current condition is a condition where watch is required. However, in this case, a person who enters the detection area together with an object (human body) having authority would become a target to be watched, and thus erroneous detection often would occur. On the other hand, according to this configuration, the condition for determining an alert is that the gate is not in the closed position and also no object is detected in the detection area. Thus, only a person who enters the detection area after an object (human body) which has triggered opening of the gate leaves the detection area is considered to be a target to be watched. As a result, a person who tries to enter at a right time after an object (human body) having authority passes can be a target to be watched, and a person who enters the detection area together with an object (human body) having authority can be excluded from targets to be watched. Therefore, erroneous determination can be minimized.

In a still further preferred embodiment, the predetermined combination is that the gate is in the closed position and an object is detected in the detection area within the second zone, and if the combination continues for a predetermined stay time, the alert condition determination module infers unauthorized stay, thereby judging the alert condition. According to this configuration, when the gate is in the closed position and an object (human body) is continuously detected in the detection area within the second zone which is not the first zone to which entry is restricted, there is a high possibility that the object is waiting for opening of the gate, in order to enter the first zone. Thus, an alert condition can be judged by a simple method.

In a preferred embodiment, the predetermined combination is that the gate is in the closed position and an object is detected in the detection area within at least one of the two zones, and when the combination occurs, the alert condition determination module infers a possibility of danger, thereby judging the alert condition. According to this configuration, an object from which it is difficult to recognize a forward area, such as a forklift in a factory, has difficulty recognizing the opposite side of the gate. On the other hand, according to this configuration, a situation which can occur around the gate, or the like, can be inferred, and thus a notification can be given to an object from which it is difficult to recognize a forward area. In particular, in the case where the gate makes visual observation from one zone to another zone difficult, this configuration is very useful in terms of safety.

Preferably, the gate includes an automatic door or an automatic shutter.

In a preferred embodiment, while the gate moves from the opened position to the closed position, if at least one of the two object detection sensors detects an object in the associated detection area, the moving direction of the gate is changed to so that the gate moves to the opened position. According to this configuration, information of detection by the object detection device is used for opening of the gate. By using the information of detection from the object detection device for inference of a current situation around the gate as well, an additional device only for determining an alert condition is not needed.

The system according to one aspect of the present invention includes the device for determining an alert condition.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a side view showing a system for a gate according to a first embodiment of the present invention and its surrounding region;

FIG. 2 is a schematic block diagram of the system in FIG. 1;

FIG. 3 is a flowchart showing an operation of the system in FIG. 1;

FIGS. 4A to 4F show a state at the time of entry determination by the system in FIG. 1 in stages, and each are a schematic top view showing object detection areas and their surrounding region in the stage;

FIG. 5 is a timing chart in an example of determination according to the operation in FIG. 3, wherein pulses (a) to (e) are regarding a door state, authentication, an outer sensor, an inner sensor, and unauthorized entry determination, respectively;

FIGS. 6A to 6D show another state at the time of entry determination by the system in FIG. 1 in stages, and each are a schematic top view showing the object detection areas and their surrounding region in the stage;

FIG. 7 is a timing chart in another example of determination according to the operation in FIG. 3, wherein pulses (a) to (e) are regarding the door state, authentication, the outer sensor, the inner sensor, and the unauthorized entry determination, respectively;

FIGS. 8A to 8F show still another state at the time of entry determination by the system in FIG. 1 in stages, and each are a schematic top view showing the object detection areas and their surrounding region in the stage;

FIG. 9 is a timing chart in still another example of determination according to the operation in FIG. 3, wherein pulses (a) to (e) are regarding the door state, authentication, the outer sensor, the inner sensor, and the unauthorized entry determination, respectively;

FIG. 10 is a flowchart showing another operation of the system in FIG. 1;

FIGS. 11A and 11B show a state at the time of stay determination by the system in FIG. 1 in stages, and each are a schematic top view showing the object detection areas and their surrounding region in the stage;

FIG. 12 is a timing chart in an example of determination according to the operation in FIG. 10, wherein pulses (a) to (e) are regarding the door state, authentication, the outer sensor, the inner sensor, and unauthorized stay determination, respectively;

FIG. 13 is a side view showing an system for a gate according to a second embodiment of the present invention and its surrounding region;

FIG. 14 is a schematic block diagram of the system in FIG. 13;

FIG. 15 is a flowchart showing an operation of the system in FIG. 13;

FIG. 16 is a side view showing a system for a gate according to a third embodiment of the present invention and its surrounding region;

FIG. 17 is a schematic block diagram of the system in FIG. 16; and

FIGS. 18A to 18F show a state at the time of entry determination by the system in FIG. 16 in stages, and each are a schematic top view showing an object detection area and its sounding region in the stage.

### DESCRIPTION OF EMBODIMENTS

Hereinafter, a system for a gate or an opening/closing body according to each embodiment of the present invention will be described based on the drawings.

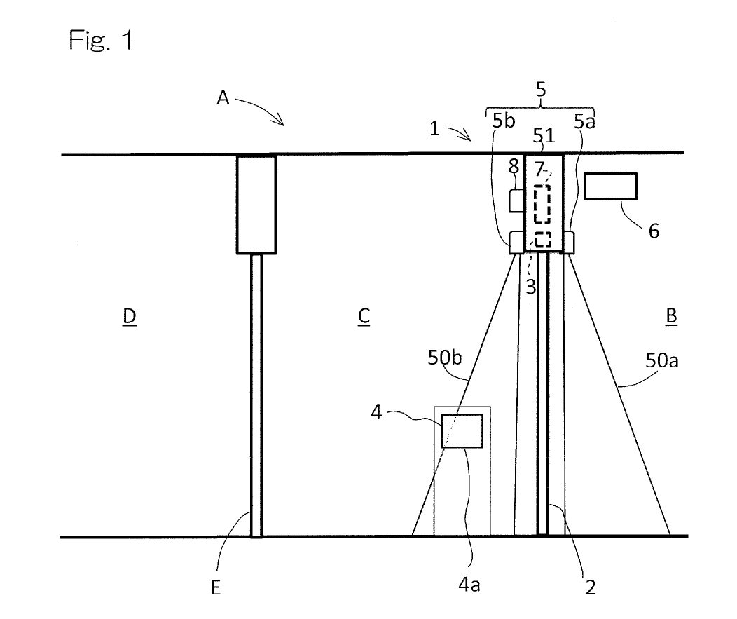

FIG. 1 shows the system 1 according to a first embodiment of the present invention. The system 1 is configured at the entrance of a building A such as a condominium. Inside the condominium A, there are a restricted zone (first zone) B and a windbreak chamber (second zone) C, and the outer side of the windbreak chamber C is an outdoor area D. Here, the restricted zone B is a zone to which entry of an object is restricted, and entry to the windbreak chamber C and the outdoor area D is not restricted. An automatic slide door 2 is provided between the restricted zone B and the windbreak chamber C, and a manual swing door E is provided between the windbreak chamber C and the outdoor area D. The system 1 allows for entry from the restricted zone B to the windbreak chamber C by opening the automatic door 2. The automatic door 2 may be a double sliding door in this embodiment, or may be a single sliding door. In addition, the door E between the windbreak chamber C and the outdoor area D may be an automatic slide door.

The system 1 includes a full closing detection device 3, an authentication device (access device) 4, an object detection device 5, and a watching state determination device (a device for determining an alert condition derived from a state of gate 2) 6.

The full closing detection device 3 detects full closing of the automatic door 2, that is, the condition in which the automatic door 2 is in a closed position. In this embodiment, the full closing detection device 3 is a limit switch. The limit switch 3 is provided at a position within a transom 51 at which position the limit switch 3 is actuated while the door 2 is fully closed. The limit switch 3 is switched ON when the door 2 is fully closed, and is switched OFF when the door 2 is opened. When the limit switch 3 is switched, a limit switch ON/OFF signal is outputted from the limit switch 3. The full closing detection device 3 may be any device as long as it is capable of detecting full closing of the automatic door 2. For example, the full closing detection device 3 may be realized by a combination of a reed switch and a magnet.

The authentication device 4 is configured to determine whether an object (human body) which tries to enter the restricted zone B has authority. The authentication device 4 in this embodiment has a body and a user interface 4a, such as a numeric keypad, provided on the top surface of the body. When an identification number is inputted with the numeric keypad, the authentication device 4 compares the inputted identification number with the registered identification numbers. When the authentication device 4 confirms matching of the identification number, the authentication device 4 determines that a person who has inputted the identification number has authority. When the authentication device 4 determines that the person has authority, the authentication device 4 outputs an authentication signal. The authentication device 4 may be placed within the windbreak chamber C and adjacent to the automatic door 2. The authentication device 4 may be any device as long as it is capable of determining presence/absence of authority. For example, authentication may be performed by means of biometric identification or an RFID tag.

The object detection device 5 includes an inner AIR (active infrared) sensor 5a and an outer AIR sensor 5b which are mounted on an inner (restricted zone B side) surface and an outer (windbreak chamber C side) surface, respectively, of the transom 51 which supports an upper end portion of the automatic door 2. The inner AIR sensor 5a and the outer AIR sensor 5b form an inner object detection area (hereinafter, referred to as “inner detection area”) 50a and an outer object detection area (hereinafter, referred to as “outer detection area”) 50b, respectively, below the mounted positions thereof and in directions away from the automatic door 2, and detect that objects are present in the detection areas 50a and 50b, respectively. Hereinafter, when either one of the inner and outer detection areas 50a and 50b is indicated, the indicated one is sometimes referred to merely as detection area. The inner and outer detection areas 50a and 50b do not necessarily need to be spaced apart from each other as shown. Both the inner detection area 50a and the outer detection area 50b may include a space on a path of the automatic door 2 to overlap each other. When the inner AIR sensor 5a and the outer AIR sensor 5b detect that objects are present within the inner and outer detection areas 50a and 50b, the inner AIR sensor 5a and the outer AIR sensor 5b output inner and outer object detection signals, respectively.

In this embodiment, the authentication device 4 is located within the outer detection area 50b. When the door is opened with authentication of the authentication device 4 as a trigger, the door can be kept opened if an authenticated person is present in the outer detection area 50b. In other words, the purpose for locating the authentication device 4 within the outer detection area 50b is for preventing an accident such as being caught in the door. In the case where the authentication device 4 uses an RFID tag, if the RFID tag is a passive type, an RFID recognition device (not shown) is disposed at the position of the shown authentication device 4. When a user puts an RFID tag-incorporated card over this device, authentication is performed. If the RFID tag is an active type or a semi-active type, an area where the RFID tag is recognized is desirably formed so as to include the outer object detection area 50b. This is also for preventing an accident of an authenticated person being caught in the door. Thus, an RFID tag-incorporated card carried by the user is recognized within this recognition area, and authentication is performed.

The watching state determination device 6 is connected to the full closing detection device 3, the authentication device 4, and the object detection device 5 by a wire (not shown). Thus, respective outputs from the devices 3, 4, and 5 are inputted to the watching state determination device 6. Instead of wired connection, the watching state determination device 6 may be wirelessly connected to the devices 3, 4, and 5 for transmission and reception of signals therebetween.

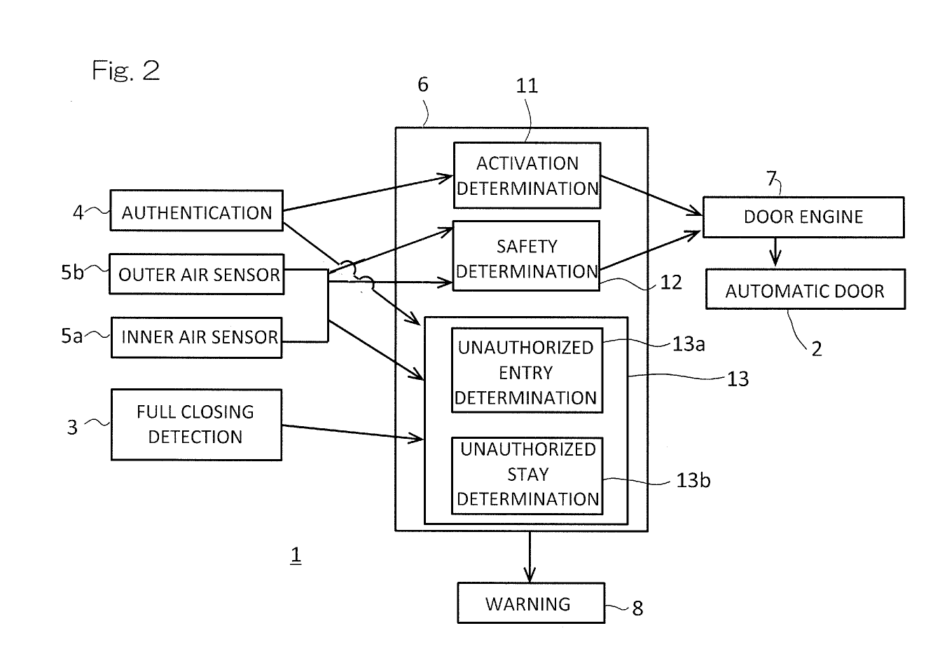

The watching state determination device 6 is connected to a door engine 7 housed within the transom 51. As the full closing detection device, means such as the above-described limit switch 3 may not be provided, and the function of the door engine 7 may be used. That is, the door engine 7 recognizes the position of the automatic door 2 as its basic function, and thus information of this position may be provided from the door engine 7 (FIG. 2) to the watching state determination device 6, and the watching state determination device 6 may recognize full closing of the automatic door 2 based on the information.

The watching state determination device 6 is also connected to a warning device 8. In this embodiment, the warning device 8 is composed of, for example, a rotating lamp, a speaker, or a combination thereof. However, the warning device 8 is not limited to them, and may be composed of any device as long as it is capable of issuing a warning.

As shown in FIG. 2, the watching state determination device 6 includes an activation determination module 11, a safety determination module 12, and a watching state determination module 13. The watching state determination device 6 includes a processor where these modules 11, 12 and 13 are implemented.

Upon reception of the outer object detection signal from the outer AIR sensor 5b and the authentication signal from the authentication device 4, or upon reception of the inner object detection signal from the inner AIR sensor 5a, the activation determination module 11 outputs an opening instruction signal to the door engine 7 so as to cause the door engine 7 to open the automatic door 2. The former case is for opening the automatic door 2 with, as a trigger, an authenticated person being about to enter the restricted zone B. Regardless of which of the outer object detection signal and the authentication signal is inputted to the watching state determination device 6 earlier, the activation determination module 11 outputs an instruction to open the automatic door 2, when both signals are inputted to the watching state determination device 6. In the latter case, the activation determination module 11 causes the automatic door 2 to be opened with, as a trigger, an object exiting from the restricted zone B to the windbreak chamber C.

Alternatively, upon reception of the authentication signal from the authentication device 4, or upon reception of the inner object detection signal from the inner AIR sensor 5a, the activation determination module 11 may output the opening instruction signal to the door engine 7 so as to cause the door engine 7 to open the automatic door 2. In this case, reception of the outer object detection signal from the outer AIR sensor 5b is not taken into account in opening the automatic door 2.

Upon reception of the object detection signal from at least one of the outer and inner AIR sensors 5b and 5a while the automatic door 2 shifts from an opened position to a closed position, the safety determination module 12 outputs the opening instruction signal to the door engine 7 so as to cause the door engine 7 to open the automatic door 2. This is for opening the automatic door 2 in order to prevent a human body from being caught in the automatic door 2 that has not been closed.

The watching state determination module 13 is configured to determine a watching state (an alert condition), and includes: an unauthorized entry determination section 13a which infers unauthorized entry to determine a watching state; and an unauthorized stay determination section 13b which infers unauthorized stay to determine a watching state.

In this embodiment, the activation determination module 11 and the safety determination module 12 are provided in the watching state determination device 6, but the present invention is not limited thereto. For example, these means 11 and 12 may be provided in the door engine 7. In this case, since the door engine 7 normally recognizes that the door 2 is closed, the activation determination module 11 and/or the safety determination module 12 performs control to open the door 2 in consideration of the door position. Alternatively, the activation determination module 11 and the safety determination module 12 may be provided in different devices. However, when the activation determination module 11 and the safety determination module 12 are provided in the watching state determination device 6 as in this embodiment, wiring is not complicated. That is, wires from the authentication device 4 and the inner and outer AIR sensors 5a and 5b do not need to be connected to the door engine 7, so that the wiring is simplified.

Next, an operation of the watching state determination device 6 will be described individually regarding unauthorized entry determination by the unauthorized entry determination section 13a and regarding unauthorized stay determination by the unauthorized stay determination section 13b.

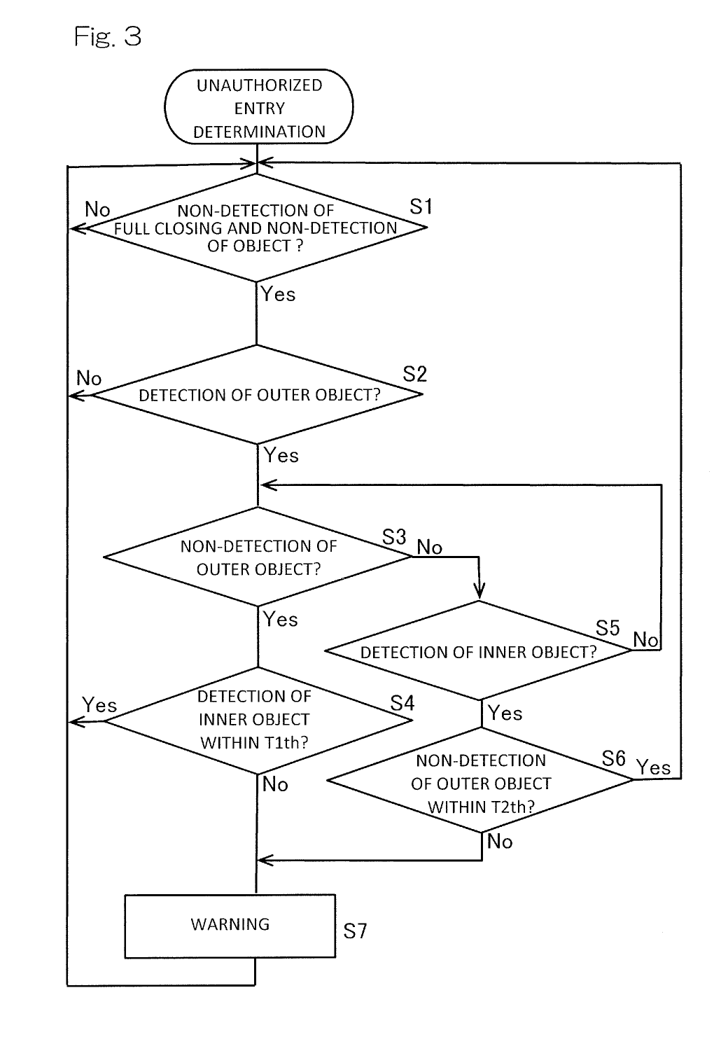

In the unauthorized entry determination, as shown in a flowchart of FIG. 3, the unauthorized entry determination section 13a (FIG. 2) determines occurrence of a combination of the automatic door 2 (FIG. 1) being not fully closed (non-detection of full closing) and no object being detected (non-detection of an object) (step S1). That is, the unauthorized entry determination section 13a determines that the automatic door 2 is not fully closed and no object has been detected in the object detection area 50.

Next, some examples of the unauthorized entry determination process will be described.

### Unauthorized Entry Determination Process (Case I of Determining Unauthorized Entry)

The following unauthorized entry determination process is, for example, a process of inferring that, when a condominium resident (hereinafter, referred to as “resident”) enters the condominium A (FIG. 1), a person who intentionally slips into the condominium A together with the resident is present, that is, a process of inferring tailgating.

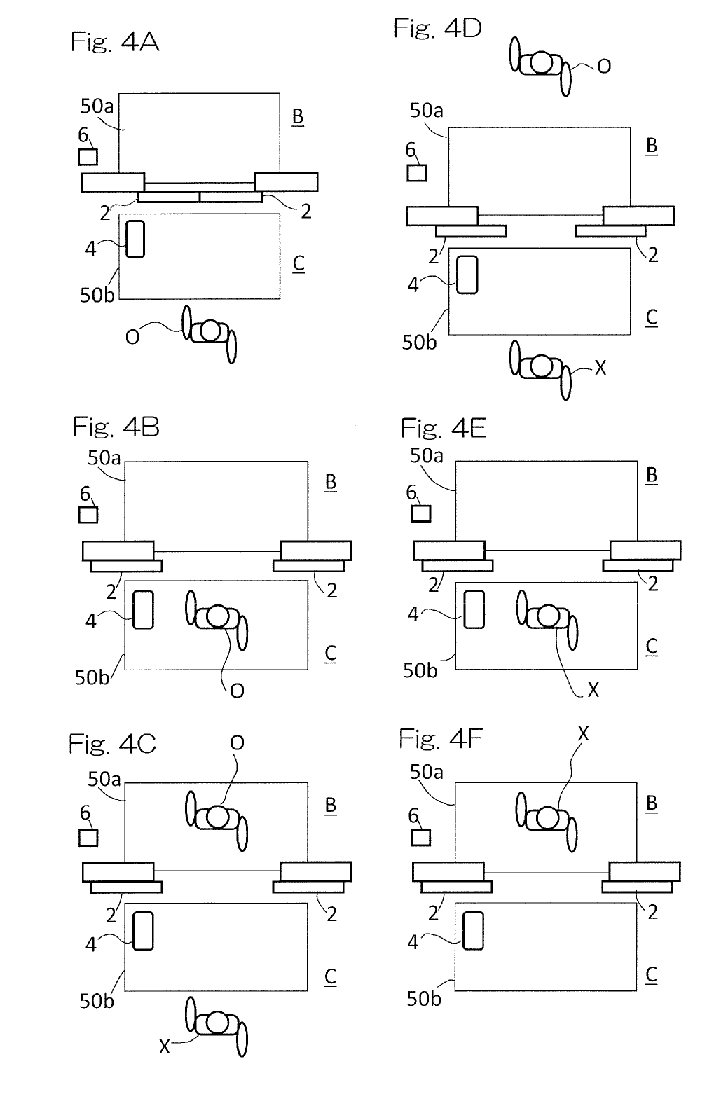

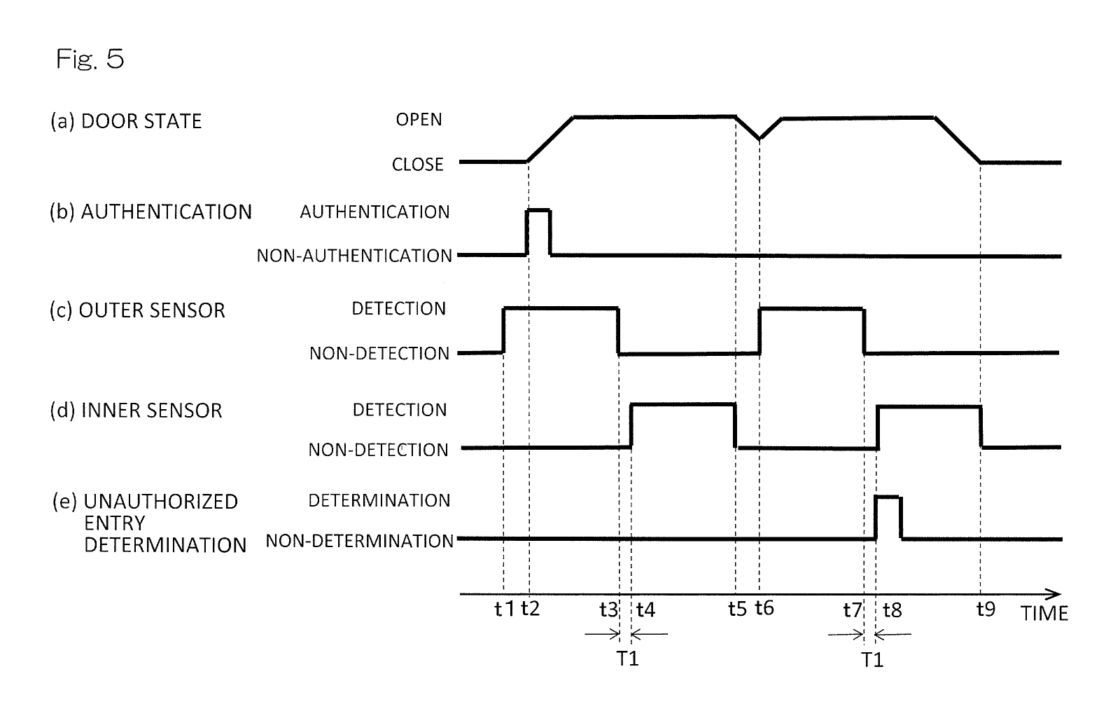

An example of a process in the case where unauthorized entry is inferred will be described with reference to FIG. 3 as well as FIGS. 4A to 4F and 5.

First, in FIG. 4A, the automatic door 2 is fully closed, and a resident O has entered the windbreak chamber C from the outdoor area D (FIG. 1) (a time prior to time t1 in FIG. 5). When the resident O stands at the outer side of the automatic door 2 as shown in FIG. 4B, that is, enters the outer detection area 50b, the watching state determination device 6 receives the outer object detection signal (time t1 in FIG. 5). When the resident O inputs a registered identification number with the numeric keypad 4a in the authentication device 4, the watching state determination device 6 receives the authentication signal (time t2 in FIG. 5). Thus, the activation determination module 11 (FIG. 2) outputs the opening instruction signal to the door engine 7 (FIG. 2). Then, as shown in FIG. 4B, the automatic door 2 shifts from a closed position to an opened position.

When the resident O comes out of the outer detection area 50b as shown in FIG. 4C, the outer object detection signal received by the watching state determination device 6 disappears (time t3 in FIG. 5). Then, when the resident O is located on the path of the automatic door 2, the resident O is not included in any of the outer detection area 50b and the inner detection area 50a. Then, when the resident O enters the inner detection area 50a, the watching state determination device 6 receives the inner object detection signal (time t4 in FIG. 5).

In this embodiment, when the resident O is located on the path of the automatic door 2, the resident O is not included in any of the outer detection area 50b and the inner detection area 50a. On the other hand, in the case where the outer detection area 50b and the inner detection area 50a each include the space on the path of the automatic door 2 and overlap each other, the resident O enters the inner detection area 50a before coming out of the outer detection area 50b. Thus, the order of falling of the detection signal of the outer AIR sensor 5b (FIG. 2) at time t3 in FIG. 5 and rising of the detection signal of the inner AIR sensor 5a (FIG. 2) at time t4 is inverted. In addition, even in the case where the areas 50a and 50b do not overlap each other, a state can occur in which a portion of the human body is included in the outer detection area 50b and another portion of the human body is included in the inner detection area 50a. In this case as well, the resident O enters the inner detection area 50a before coming out of the outer detection area 50b.

As shown in FIG. 4C, an unauthorized person X who is not a condominium resident and does not know the identification number for the authentication device 4 (hereinafter, referred to as “unauthorized person”) observes that the automatic door 2 is opened due to the resident O. The unauthorized person X tries to pass through the automatic door 2 that has been opened, to enter the restricted zone B. While the resident O is located in the object detection area 50, the object detection signal is inputted to the safety determination module 12 (FIG. 2), and the safety determination module 12 outputs the opening instruction signal to the door engine 7, so that the automatic door 2 is fully opened.

When the resident O comes out of the inner detection area 50a as shown in FIG. 4D, the watching state determination device 6 no longer receives the inner object detection signal (time t5 in FIG. 5). Thus, the safety determination module 12 outputs a closing instruction signal to the door engine 7 (FIG. 2), so that the automatic door 2 shifts from an opened position to a closed position.

As shown in FIG. 4E, while keeping a distance from the resident O, at a right time when the resident O moves away from the automatic door 2, the unauthorized person X enters the outer detection area 50b in order to try to pass through the automatic door 2 that is shifting from an opened position to a closed position, to enter the restricted zone B.

When the unauthorized person X enters the outer detection area 50b, the watching state determination device 6 receives the outer object detection signal (time t6 in FIG. 5). Thus, the safety determination module 12 (FIG. 2) outputs the opening instruction signal to the door engine 7 (FIG. 2) in order to prevent the automatic door 2 from sandwiching a human body. Accordingly, the automatic door 2 that is shifting from an opened position to a closed position reverses its moving direction to shift to an opened position.

As shown in FIG. 4F, the unauthorized person X enters the restricted zone B since the automatic door 2 is opened. When the unauthorized person X comes out of the outer detection area 50b, the watching state determination device 6 no longer receives the outer object detection signal (time t7 in FIG. 5). When the unauthorized person X enters the inner detection area 50a next, the watching state determination device 6 receives the inner object detection signal (time t8 in FIG. 5). At the time (time t8 in FIG. 5), it is determined that unauthorized entry is present. Then, the unauthorized person X comes out of the inner detection area 50a (time t9 in FIG. 5).

This process of determining unauthorized entry will be described in detail below with reference to FIG. 3 again.

The unauthorized entry determination section 13a (FIG. 2) determines whether the automatic door 2 is not fully closed and no object has been detected (step S1). The reason for determining whether the automatic door 2 is not fully closed is that, since the automatic door 2 that has been opened has not been fully closed yet, there is a possibility that the unauthorized person X can enter the restricted zone B. The determination as to whether the automatic door 2 is not fully closed and no object is detected is satisfied, for example, only when this state (not fully closed and no object being detected) has continued for a time period longer than a certain detection difference time period threshold T1ₜₕ. The detection difference time period threshold T1ₜₕ is for taking into account the fact that the outer detection area 50b and the inner detection area 50a are spaced apart from each other or overlap each other, as described later. By using the detection difference time period threshold T1ₜₕ for the determination as to a state of not being fully closed and no object being detected, in a state where the resident O or the like is located on the path of the automatic door 2, it can be prevented from being determined that it is in a state that there is a possibility that the unauthorized person X can enter the restricted zone B.

In the state of FIG. 4A, the unauthorized entry determination section 13a determines that the automatic door 2 is fully closed and no object has been detected, and returns to step S1 (“No” in step S1). When the resident O enters the outer detection area 50b as shown in FIG. 4B, the unauthorized entry determination section 13a (FIG. 2) determines that the automatic door 2 is not fully closed but an object has been detected, and returns to step S1 (“No” in step S1).

When the resident O comes out of the outer detection area 50b and is located on the path of the automatic door 2, since the resident O is not included in any of the outer detection area 50b and the inner detection area 50a, the automatic door 2 is not fully closed, and no object is detected. However, a time period from the time when the resident O comes out of the outer detection area 50b to the time when the resident O enters the inner detection area 50a is short, and thus is within the detection difference time period threshold T1ₜₕ. Therefore, the unauthorized entry determination section 13a (FIG. 2) does not determine that the automatic door 2 is not fully closed and no object has been detected, and returns to step S1 (“No” in step S1). When a signal other than the object detection signal is received while waiting for the object detection signal, a process corresponding to the received signal may be performed. The flowcharts in the present specification, however, show only processes required for describing the embodiments.

When the resident O moves from the outer detection area 50b to the inner detection area 50a as shown in FIG. 4C, the unauthorized entry determination section 13a (FIG. 2) determines that the automatic door 2 is not fully closed but an object has been detected (“No” in step S1). At the time when the resident O comes out of the inner detection area 50a as shown in FIG. 4D, the automatic door 2 is shifting from an opened position to a closed position and is not fully closed. Thus, the unauthorized entry determination section 13a determines that the automatic door 2 is not fully closed and no object has been detected, and proceeds to step S2 (“Yes” in step S1). The unauthorized entry determination section 13a (FIG. 2) waits until receiving the object detection signal (“No” in step S2).

When the unauthorized person X enters the outer detection area 50b as shown in FIG. 4E, the unauthorized entry determination section 13a (FIG. 2) determines that the outer object detection signal has been received, and proceeds to step S3 (“Yes” in step S2). The unauthorized entry determination section 13a (FIG. 2) waits until the outer object detection signal is no longer received or the inner object detection signal is received.

When the unauthorized person X comes out of the outer detection area 50b and is located on the path of the automatic door 2, the unauthorized person X is not included in any of the outer detection area 50b and the inner detection area 50a, and thus the unauthorized entry determination section 13a determines that the outer object detection signal is no longer received (“Yes” in step S3). Then, the unauthorized entry determination section 13a determines whether the inner object detection signal is received within the detection difference time period threshold T1ₜₕ from this time point (step S4).

In the process of step S4, the fact that the outer detection area 50b and the inner detection area 50a are spaced apart from each other is taken into account. That is, this process is for determining whether an object has moved from the outer detection area 50b to the inner detection area 50a. In the case where the detection areas 50b and 50a are spaced from each other, a time period during which the object detection signal is not detected, that is, a detection difference time period, is present. For example, a time period T1 from time t3 to time t4 in FIG. 5 is a detection difference time period due to the fact that the detection areas 50b and 50a are spaced apart from each other.

On the other hand, in the case where the detection areas 50b and 50a overlap each other, the unauthorized person X near the path of the automatic door 2 is also included in the inner detection area 50a before coming out of the outer detection area 50b. Thus, the unauthorized entry determination section 13a determines whether the inner object detection signal is received (step S5), while the outer object detection signal is received (“No” in step S3). However, if the inner object detection signal is not received while the outer object detection signal is received (“No” in step S3), the unauthorized entry determination section 13a waits until the outer object detection signal disappears or until the inner object detection signal is received (“No” in step S5). When the inner object detection signal is received (“Yes” in step S5), the unauthorized entry determination section 13a determines whether the outer object detection signal is received within a detection difference time period threshold T2ₜₕ from this time point (step S6). That is, in the case where the detection areas 50b and 50a overlap each other, or in the case where the areas 50b and 50a do not overlap each other but a case can occur in which a portion of the human body is included in the outer detection area 50b and another portion of the human body is included in the inner detection area 50a, a time period during which both the outer and inner object detection signals are detected, that is, a detection difference time period T2, is present. For example, when the order of time t3 and time t4 in FIG. 5 is inverted, a time period T2 (not shown) from time t4 at which the inner object detection signal is received to time t3 at which the outer object detection signal disappears is a detection difference time period due to the fact that the detection areas 50b and 50a overlap each other.

Here, the detection difference time period thresholds T1ₜₕ and T2ₜₕ are set based on a normal walking time. In step S4 or S6 described above, if the detection difference time period is longer than the detection difference time period threshold T1ₜₕ or T2ₜₕ, it is inferred that movement between the outer and inner detection areas 50b and 50a has not been detected and another object has been detected. Therefore, if no inner object detection signal is received within the detection difference time period threshold T1ₜₕ from the time at which the outer object detection signal is no longer received (“No” in step S4), the unauthorized entry determination section 13a (FIG. 2) returns to step S1. Similarly, if the outer object detection signal remains being received during the detection difference time period threshold T2ₜₕ from the time at which the inner object detection signal is received (“No” in step S6), the unauthorized entry determination section 13a (FIG. 2) returns to step S1.

When the unauthorized person X moves from the outer detection area 50b to the inner detection area 50a as shown in FIG. 4F, the unauthorized entry determination section 13a (FIG. 2) determines that the inner object detection signal has been received within the detection difference time period threshold T1ₜₕ from the time at which the outer object detection signal is no longer received (“Yes” in step S4). Similarly, for example, in the case where the detection areas 50b and 50a overlap each other, the unauthorized entry determination section 13a (FIG. 2) determines that the outer object detection signal has no longer been received within the detection difference time period threshold T2ₜₕ from the time at which the inner object detection signal is received (“Yes” in step S6). In these cases, the unauthorized entry determination section 13a (FIG. 2) infers unauthorized entry to determine that the current state is a watching state, and outputs a warning signal to the warning device 8 (FIG. 2) (step S7). The reason why such a determination is made is that, after a state occurs in which the automatic door 2 is not fully closed and a human body or the like is not present in the object detection area 50, when an object is detected in the outer detection area 50b and then detected in the inner detection area 50a, it is inferred that a person who had not inputted the identification number entered the restricted zone B through the automatic door 2 that is shifting to close is present.

The warning device 8 may include a rotating lamp or a speaker, or both of them. Upon receiving the warning signal, the warning device 8 discourages the unauthorized person X from being in the building by lighting up or blinking the rotating lamp and/or by means of a buzzer or beeping sound or an announcement, such as “Please input identification number for entry.” in the speaker. Even if the warning is issued, for example, the devices are not stopped, so that normal operation of an automatic door system continues.

As described above, in the system 1 according to this embodiment, if unauthorized entry is inferred, a warning is issued, but operation of the automatic door system is not stopped. Therefore, for example, even if a friend accompanying the resident in the condominium A or a resident's small child who cannot input the identification number is about to enter the restricted zone B while keeping a large distance from the resident who has inputted the identification number, a warning is issued, but entry to the restricted zone B is not prohibited. Thus, there is no problem with operation of the system 1.

### Unauthorized Entry Determination Process (Case: Not Determining Unauthorized Entry)

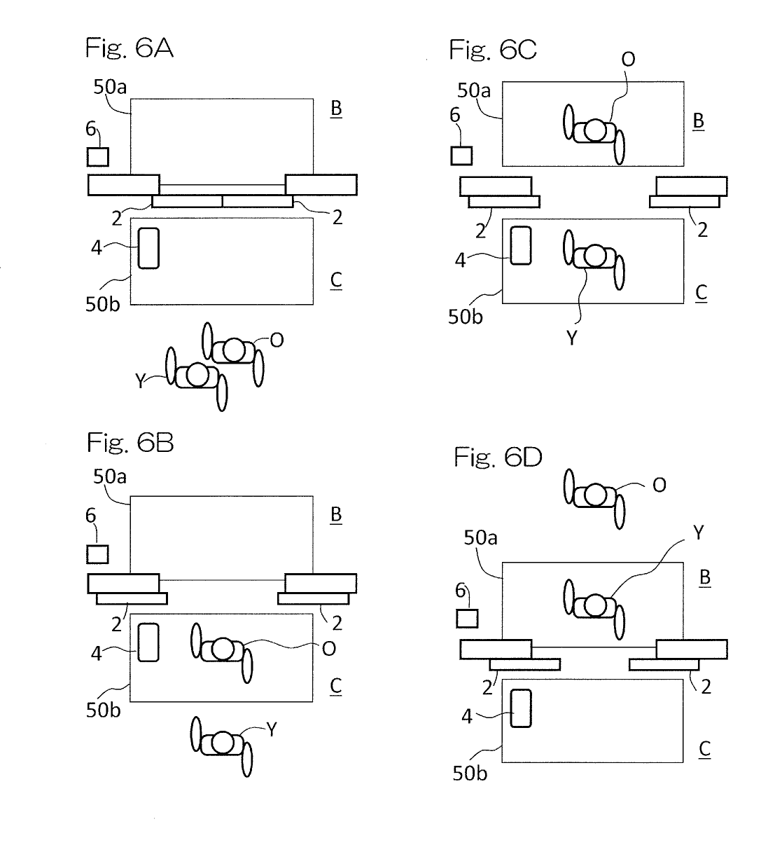

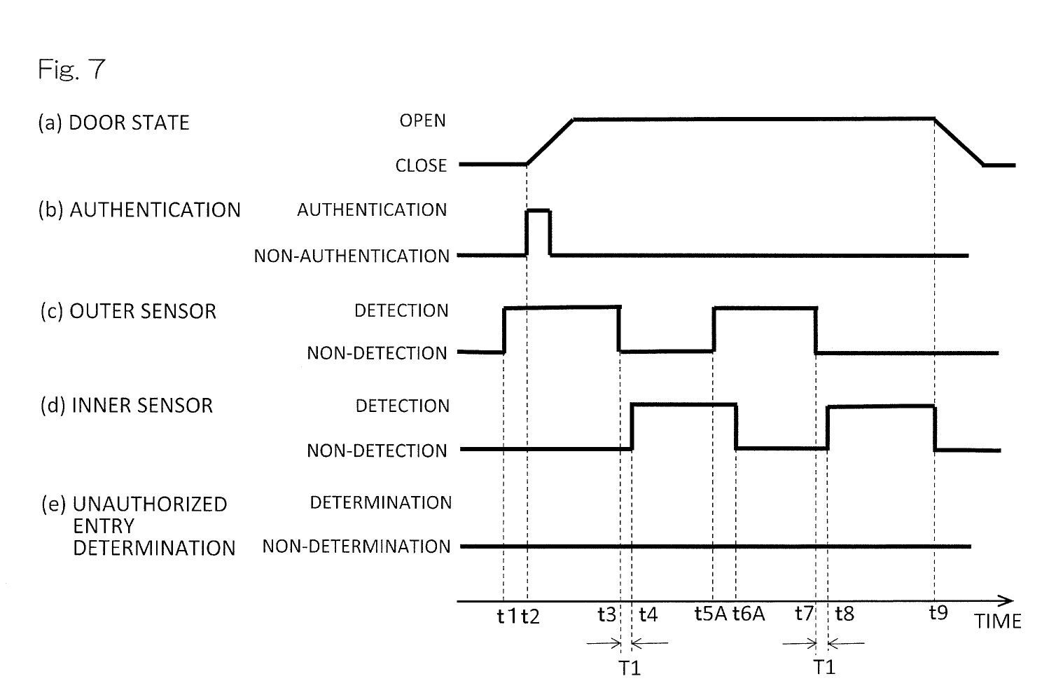

A process in the case where, together with the resident O in the condominium A, their friend is about to enter the condominium, will be described with reference to FIG. 3, which has been already referred to, and FIGS. 6A to 6D and 7.

FIGS. 6A and 6B correspond to FIGS. 4A and 4B, respectively, and states at times t1 to t4 in FIG. 7 also correspond to states at times t1 to t4 in FIG. 5, respectively. This determination process is different from the determination process described with reference to FIGS. 4A to 4F and 5, in that a person walking just behind the resident O is a friend Y of the resident O (hereinafter, referred to as “friend”).

As shown in FIG. 6C, the distance between the resident O and the friend Y is shorter than the distance between the resident O and the unauthorized person X shown in FIG. 4C. When the friend Y enters the outer detection area 50b before the resident O comes out of the inner detection area 50a, the watching state determination device 6 receives the outer object detection signal (time t5A in FIG. 7). Thereafter, when the resident O comes out of the inner detection area 50a as shown in FIG. 6D, the watching state determination device 6 no longer receives the inner object detection signal (time t6A in FIG. 7). When the friend Y comes out of the outer detection area 50b, the watching state determination device 6 no longer receives the outer object detection signal (time t7 in FIG. 7). When the friend Y enters the inner detection area 50a, the watching state determination device 6 receives the inner object detection signal (time t8 in FIG. 7). The unauthorized entry determination section 13a (FIG. 2) does not infer unauthorized entry. This is because a state does not occur in which the automatic door 2 is not fully closed and a human body or the like is not present in the object detection area 50, and since this state is not passed, even though the friend Y following the resident O has not inputted the identification number and has entered the restricted zone B, it is inferred that the friend Y is accompanying the resident O.

In each state described above, the unauthorized entry determination section 13a performs the determination process in FIG. 3 which has been already described.

In the states of FIGS. 6A and 6B, the process described with reference to FIGS. 4A and 4B is performed.

When the friend Y enters the outer detection area 50b before the resident O comes out of the inner detection area 50a as shown in FIG. 6C, the unauthorized entry determination section 13a determines that the automatic door 2 is not fully closed and an object has been detected (“No” in step S1). Therefore, the unauthorized entry determination section 13a does not proceed to step S2. Even when the friend Y enters as shown in FIG. 6D, it is not determined that the automatic door 2 is not fully closed and no object has been detected, and thus the unauthorized entry determination section 13a does not proceed to step S2 and returns to step S1.

The friend Y is a person who enters the restricted zone B without being authenticated, but this entry is not regarded as unauthorized entry, and thus no warning is issued. Therefore, the system 1 according to this embodiment works effectively, particularly, in practical use in which, as in access control at a condominium, not all entries of people who do not have authority should be determined as unauthorized entry.

### Unauthorized Entry Determination Process (Case II of Determining Unauthorized Entry)

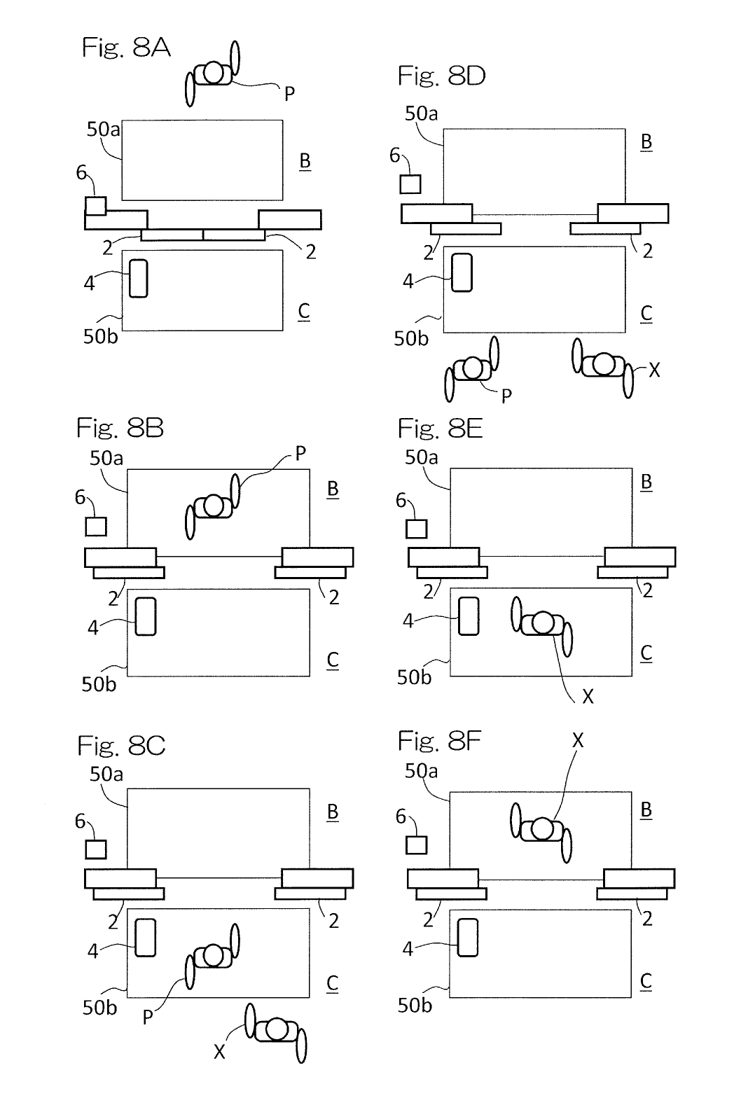

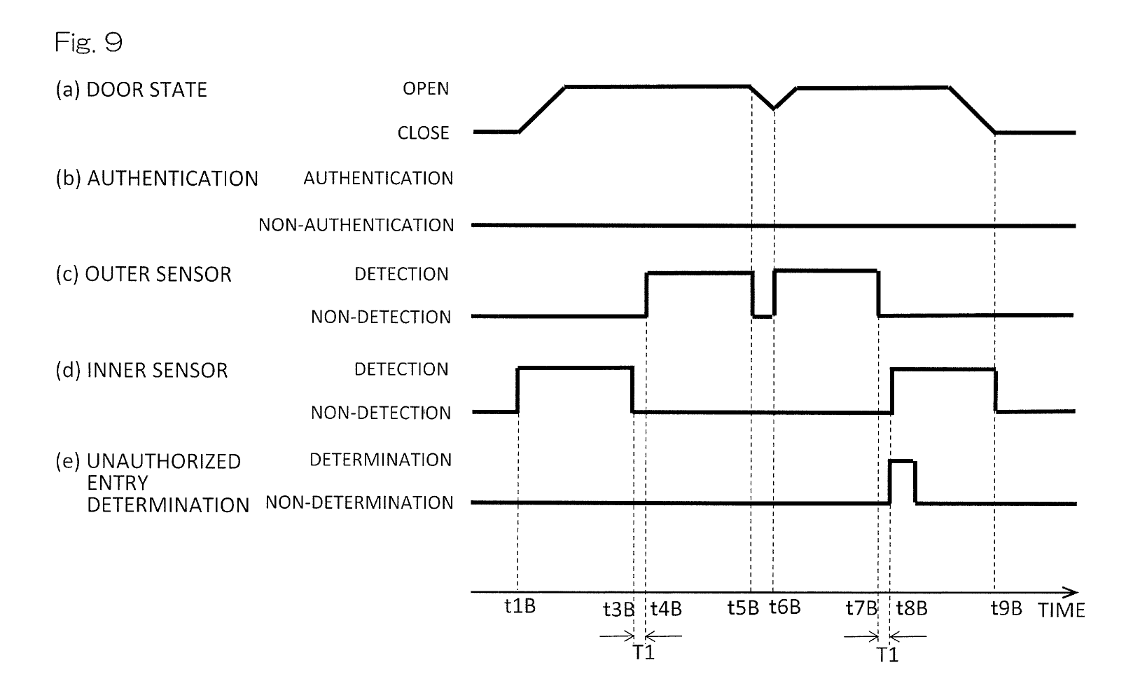

A process in the case where unauthorized entry is inferred will be described with reference to FIG. 3, which has been already referred to, and FIGS. 8A to 8F and 9. This process is different from the process in the case where unauthorized entry is inferred as described above with reference to FIGS. 4A to 4F and 5, in that a person moves from the restricted zone B to the windbreak chamber C. The person may be or may not be a resident in the condominium A who has authority.

First, in FIG. 8A, the automatic door 2 is fully closed (a time prior to time t1B in FIG. 9). When a person P enters the inner detection area 50a, the watching state determination device 6 receives the inner object detection signal (time t1B in FIG. 9). The activation determination module 11 of the watching state determination device 6 outputs the opening instruction signal to the door engine 7. Then, the automatic door 2 shifts from a closed position to an opened position as shown in FIG. 8B. Authentication is not required when going out from the restricted zone B.

When the person P comes out of the inner detection area 50a as shown in FIG. 8C, the inner object detection signal received by the watching state determination device 6 disappears (time t3B in FIG. 9). Then, when the person P is located on the path of the automatic door 2, the person P is not included in any of the inner detection area 50a and the outer detection area 50b. Thereafter, when the person P enters the outer detection area 50b, the watching state determination device 6 receives the outer object detection signal (time t4B in FIG. 9).

As shown in FIG. 8C, the unauthorized person X observes that the automatic door 2 is opened. The unauthorized person X tries to pass through the automatic door 2 that has been opened, to enter the restricted zone B.

When the person P comes out of the outer detection area 50b as shown in FIG. 8D, the watching state determination device 6 no longer receives the outer object detection signal (time t5B in FIG. 9). Thus, the safety determination module 12 outputs the closing instruction signal to the door engine 7, so that the automatic door 2 shifts from an opened position to a closed position.

A subsequent process is the same as described with reference to FIGS. 4A to 4F and 5. That is, FIGS. 8E and 8F show the same states as FIGS. 4E and 4F, respectively, and states at times t6B to t8B in FIG. 9 are the same as the states at times t6 to t8 in FIG. 5.

In each state described above, the unauthorized entry determination section 13a performs a determination process described below with reference to FIG. 3.

The unauthorized entry determination section 13a determines whether the automatic door 2 is not fully closed and no object has been detected (step S1).

In the state of FIG. 8A, the unauthorized entry determination section 13a determines that the automatic door 2 is fully closed and no object has been detected, and returns to step S1 (“No” in step S1). When the person P enters the inner detection area 50a as shown in FIG. 8B, the unauthorized entry determination section 13a (FIG. 2) determines that the automatic door 2 is not fully closed but an object has been detected, and returns to step S1 (“No” in step S1).

When the person P comes out of the inner detection area 50a and is located on the path of the automatic door 2, since the person P is not included in any of the inner detection area 50a and the outer detection area 50b, the automatic door 2 is not fully closed, and no object is detected. However, a time period from the time when the person P comes out of the inner detection area 50a to the time when the person P enters the outer detection area 50b is short, and thus is within the detection difference time period threshold T1ₜₕ. Therefore, the unauthorized entry determination section 13a (FIG. 2) does not determine that the door 2 is not fully closed and no object has been detected, and returns to step S1 (“No” in step S1).

When the person P has moved from the inner detection area 50a to the outer detection area 50b as shown in FIG. 8C, the unauthorized entry determination section 13a (FIG. 2) determines that the automatic door 2 is not fully closed but an object has been detected (“No” in step S1).

A process in the states of FIGS. 8D to 8F is as described with reference to FIGS. 4D to 4F.

As described above, the triggers for opening the automatic door 2 are different between the cases described with reference to FIGS. 4A to 4F and 8A to 8F. However, regardless of these triggers, a person who tries to enter the condominium A while keeping a distance or time from a person who leads to opening of the automatic door 2 is inferred as a person who intentionally slips into the condominium A at a right time after the person who leads to opening of the automatic door 2 moves away from the automatic door 2.

Next, a process performed by the unauthorized stay determination section 13b of the watching state determination module 13 in FIG. 2 will be described. Both the unauthorized stay determination section 13b and the unauthorized entry determination section 13a are mounted in the watching state determination device 6, and the processes of these determination sections 13a and 13b are executed in parallel.

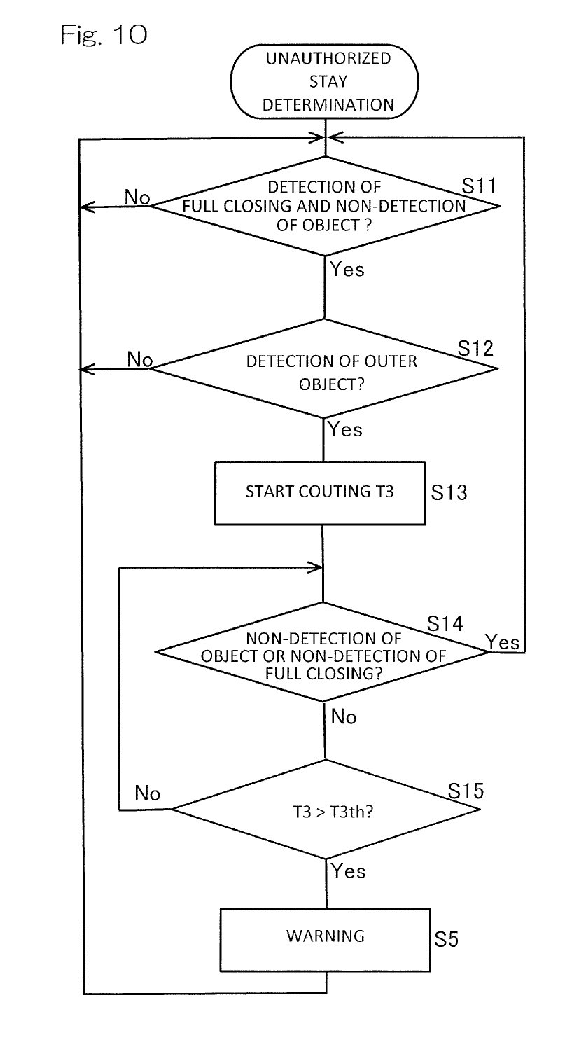

As shown in FIG. 10, the unauthorized stay determination section 13b determines whether the current state is a state where the automatic door 2 is fully closed and no object is detected (step S1). That is, the unauthorized stay determination section 13b determines that the automatic door 2 is fully closed and no object is detected in the object detection area 50.

### Unauthorized Stay Determination Process (Determining Unauthorized Stay)

The following unauthorized stay determination process is, for example, a process of inferring that a person who tries to intentionally slip into the condominium A when the automatic door 2 is opened due to another person is staying around the automatic door 2.

A process in the case where unauthorized stay is inferred will be described with reference to FIGS. 10 to 12.

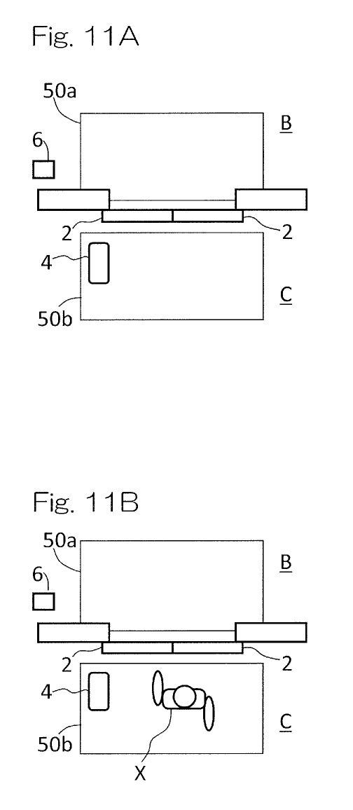

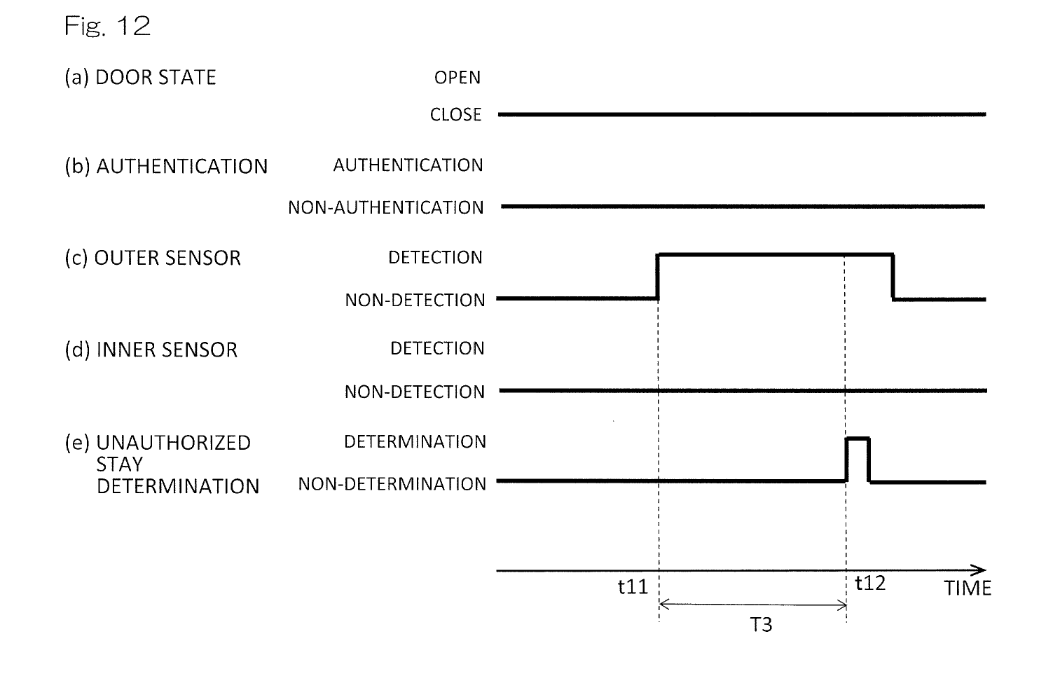

First, in FIG. 11A, the automatic door 2 is fully closed (a time prior to time t11 in FIG. 12). As shown in FIG. 11B, the unauthorized person X who tries to enter the restricted zone B of the condominium A, that is, the unauthorized person X who is about to wait for opening of the automatic door 2, enters the windbreak chamber C and stays within the outer detection area 50b (time t11 in FIG. 12).

The unauthorized stay determination section 13b performs a determination process described below with reference to FIG. 10.

In the state of FIG. 11A, the unauthorized stay determination section 13b (FIG. 2) determines whether the automatic door 2 is fully closed and no object has been detected (step S11). When the unauthorized person X enters the outer detection area 50b as shown in FIG. 11B (“Yes” in step S11), the unauthorized stay determination section 13b determines whether the outer object detection signal has been received (step S12). If the unauthorized stay determination section 13b (FIG. 2) determines that the outer object detection signal has been received (“Yes” in step S12), the unauthorized stay determination section 13b starts counting a stay time T3 (step S13). Then, if the object is no longer detected or the automatic door 2 is no longer fully closed while the stay time T3 is counted (“Yes” in step S14), the unauthorized stay determination section 13b returns to step S11.

On the other hand, as long as the unauthorized stay determination section 13b determines that the automatic door 2 is fully closed and the object has been detected, the unauthorized stay determination section 13b continues counting (“No” in step S14). The unauthorized stay determination section 13b compares the currently counted stay time T3 with a predetermined stay time threshold T3th (step S15). If the currently counted stay time T3 is less than the stay time threshold T3th (“No” in step S15), the unauthorized stay determination section 13b returns to the determination as to whether the object detection signal is no longer received or a signal indicating that the automatic door 2 is no longer fully closed is received (step S14). According to the determination in step S14, the process either returns to step S11 or continues to count the stay time T3. If the currently counted stay time T3 exceeds the stay time threshold T3th (“Yes” in step S15), the unauthorized stay determination section 13b outputs the warning signal to the warning device 8. The warning device 8 that has received the warning signal discourages the unauthorized person X from staying near the door 2 by lighting up or blinking a rotating lamp and/or by means of a buzzer or beeping sound or an announcement, such as “Here is a controlled area. Please leave here.” or “Please input identification number for entry.” In addition, an additional warning device 8 may be provided in the restricted zone B, and may give a notification that the current state is a watching state, by means of an announcement, such as “An unauthorized person may be staying outside.”, upon reception of the warning signal.

The reason for determining unauthorized stay as described above is that, if a human body or the like is detected within the outer detection area 50b during a certain period (longer than the stay time threshold T3th) even when the automatic door is fully closed, it is inferred that a person who tries to intentionally slip into the restricted zone B is waiting for opening of the automatic door 2 due to another person. The stay time threshold T3th is a predetermined value, but is not limited to a fixed value and may be a variable value. For example, the stay time threshold T3th may be a value depending on hours.

In this manner, unauthorized stay can be accurately inferred and handled as appropriate. Even if the warning is issued, for example, the devices are not stopped, and normal operation of the automatic door system continues.

In this embodiment, the windbreak chamber C is a non-restricted zone, but may be a restricted zone. In this case, restriction of entry to the restricted zone B is stricter than restriction of entry to the windbreak chamber C.

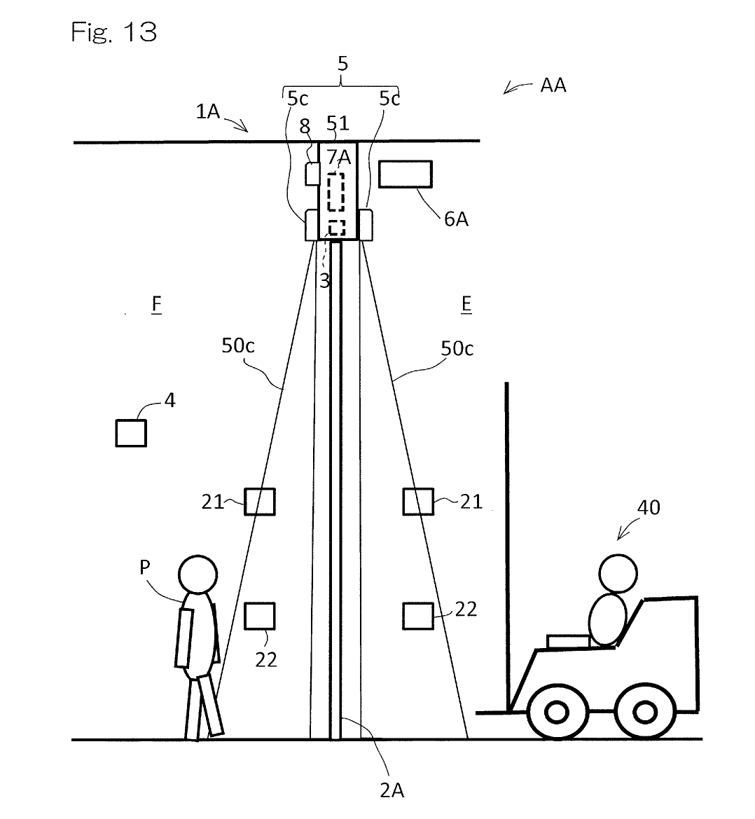

An system for a gate according to a second embodiment of the present invention will be described with reference to FIG. 13. In this embodiment, the same elements as those in the first embodiment are designated by the same reference numerals, and the description thereof is omitted. The system 1A is provided in a building AA such as a factory. In the building B, not only a person P but also a forklift 40 comes and goes. In the building, zones E and F are partitioned, and an automatic slide sheet shutter 2A is provided therebetween. The sheet shutter 2A is transparent, but lights are dimmed in the factory, so that it is difficult to recognize a state at the opposite side of the sheet shutter 2A. Thus, the sheet shutter 2A makes visual observation between the zones E and F difficult.

The system 1A includes a full closing detection device 3, an object detection device 5, and a watching state determination device 6A. The system 1A further includes a first starting device (access device) 21 and a second starting device (access device) 22. The starting devices 21 and 22 serve to open the automatic shutter 2A, and are provided at each of both sides of the automatic shutter 2A. The first starting device 21 may be remotely controlled by a remote controller (not shown), so that a start command is inputted thereto. The second starting device 22 is composed of a push button, and is provided at a height which is suitable for the person P. The starting devices 21 and 22, particularly, the first starting device 21 may be composed of an authentication device, and may be composed of, for example, the RFID recognition device. Each of the first and second starting devices 21 and 22 outputs a start signal in response to an event such as an operation of an ON button of the remote controller, pressing a button, or recognition of an RFID.

The watching state determination device 6A is connected to the full closing detection device 3, the object detection device 5, and the starting devices 21 and 22. The watching state determination device 6A is connected to a shutter engine 7A housed within a transom 51. The watching state determination device 6A is also connected to a warning device 8. The warning device 8 in this embodiment gives a notification that the current state is a watching state.

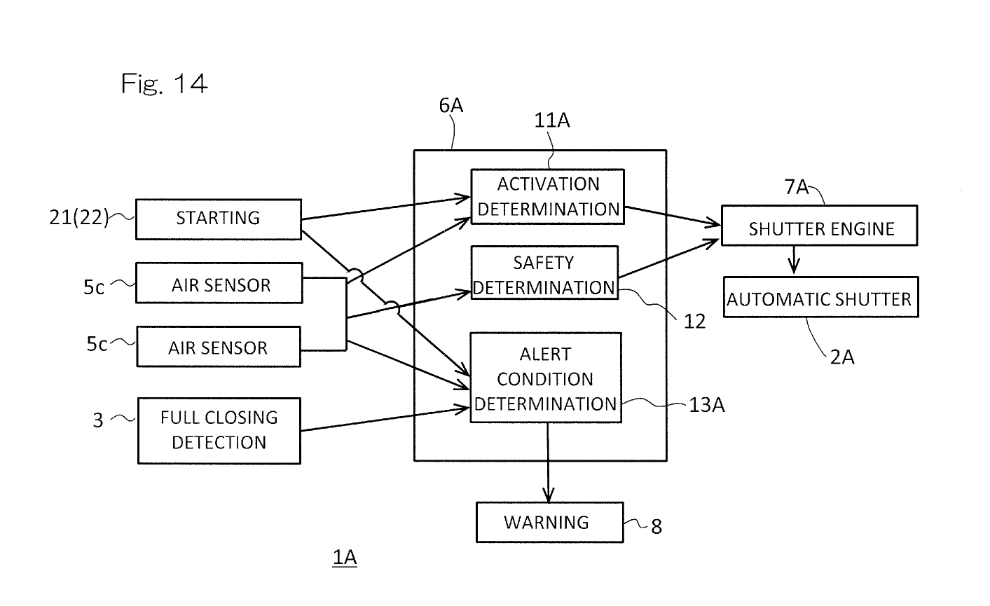

As shown in FIG. 14, the watching state determination device 6A includes an activation determination module 11A, a safety determination module 12, and a watching state determination module 13A. In this embodiment as well, the activation determination module 11A and the safety determination module 12 may be provided in any device.

Upon reception of the start signal from the starting device 21 or 22, the activation determination module 11A outputs an opening instruction signal to the shutter engine 7A so as to cause the shutter engine 7A to open the automatic shutter 2A.

An operation of the watching state determination device 6A will be described.

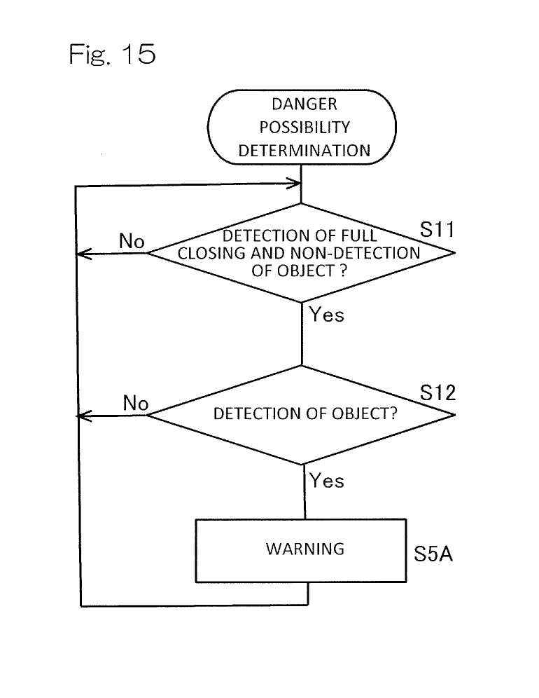

As shown in FIG. 15, the watching state determination module 13A determines whether the automatic shutter 2A is fully closed and no object has been detected (step S11). That is, the watching state determination module 13A determines that the automatic shutter 2A is fully closed and no object is detected in the object detection area 50.

Next, an example of a process of the watching state determination device 6A will be described.

### Danger Possibility Determination Process

The following danger possibility determination process is, for example, a process of inferring that the person P is present near the automatic shutter 2A in the factory B. In the factory B, the forklift 40 comes and goes. When the automatic shutter 2A is closed, a state at the opposite side of the automatic shutter 2A cannot be recognized. For example, even when the person P is located in front of the automatic shutter 2A in the zone F, an operator who operates the forklift 40 that is about to enter the zone F from the zone E does not recognize the person P. Thus, in the danger possibility determination process, the operator is notified by issuing a warning.

Referring to FIG. 15, as shown in step S11, the watching state determination module 13A (FIG. 14) determines whether the automatic shutter 2A is fully closed and an object has been detected. When the person P enters an object detection area 50c (“Yes” in step S11), the watching state determination module 13A determines that an object detection signal has been received (step S12). When the watching state determination module 13A determines that the object detection signal has been received (“Yes” in step S12), the watching state determination module 13A outputs a warning signal to the warning device 8. The warning device 8 that has received the warning signal put out an alter by lighting up or blinking a rotating lamp and/or issues by means of a buzzer or beeping sound or an announcement, such as “A person is present in front of the shutter. Please take care.” In this manner, in this embodiment, the warning device 8 gives a notification that the person is present in the object detection area 50.

The process of the watching state determination module 13A according to this embodiment corresponds to a process in which, in the process (FIG. 10) of the unauthorized stay determination section 13b according to the first embodiment, the stay time T3 is not counted, that is, the stay time threshold T3th is set to 0.

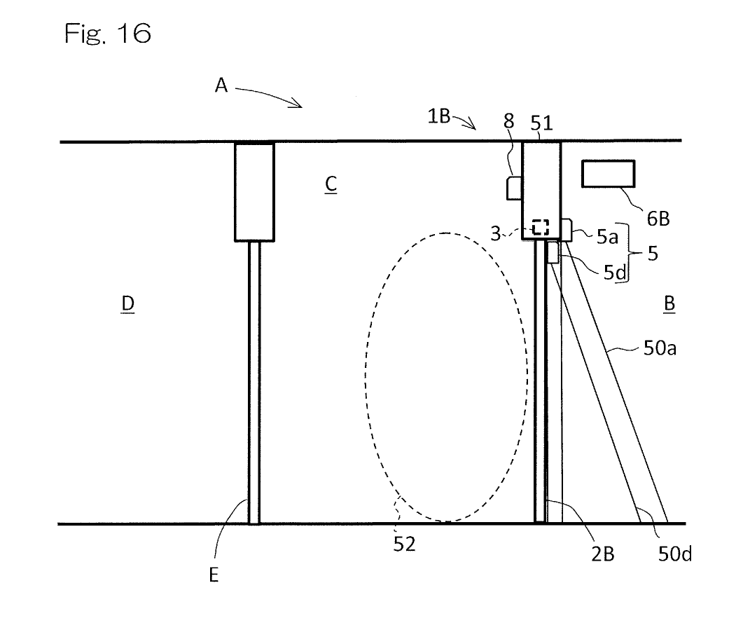

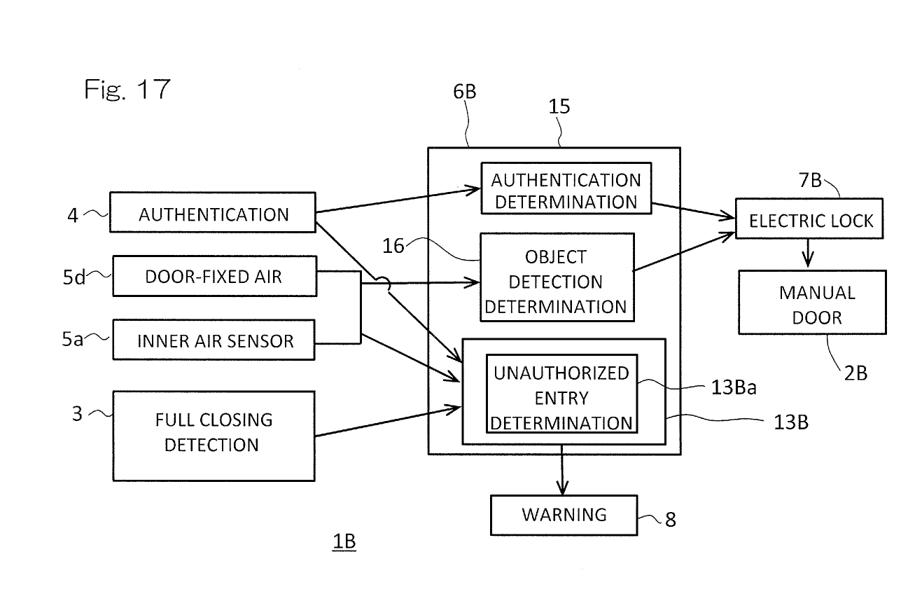

An system 1B for a gate according to a third embodiment of the present invention will be described with reference to FIG. 16. The system 1B according to this embodiment is different from the system 1 according to the first embodiment, in that the gate include a manual swing door 2B. In addition, the authentication device 4 (shown in FIG. 17 and described later) is composed of an RFID recognition device which is not shown. The RFID recognition device 4 is an active type or a semi-active type, and recognizes an RFID tag within an RFID authentication area 52 formed near the manual door 2B and within a windbreak chamber C. The authentication device 4 may be a device employing another method. For example, the authentication device may be a numeric keypad or may employ biometric identification.

The system 1B includes a door-fixed AIR sensor 5d instead of the outer AIR sensor. The door-fixed AIR sensor 5d is mounted on an upper end portion of the manual swing door 2B. When the door 2B is closed, the door-fixed AIR sensor 5d forms a movable object detection area (hereinafter, referred to as “movable detection area”) 50d within a restricted zone B. The object detection area 50d changes its position as the door 2B moves.

As shown in FIG. 17, a watching state determination device 6B of the system 1B includes an authentication determination module 15, an object detection determination module 16, and a watching state determination module 13B. In this embodiment, the authentication determination module 15 and the object detection determination module 16 may be provided in any device, similarly to the activation determination module 11 and the safety determination module 12 in the first and second embodiments.

The authentication determination module 15 is configured to receive an authentication signal from the authentication device 4 and to output a permission instruction signal to an electric lock 7B so as to permit opening of the manual door 2B. The object detection determination module 16 is configured to receive an object detection signal from an inner AIR sensor 5a and the door-fixed AIR sensor 5d. The watching state determination module 13B is configured to determine a watching state, and includes an unauthorized entry determination section 13Ba which infers unauthorized entry to determine a watching state. In this embodiment as well, similarly to the first embodiment, the watching state determination module 13B may include an unauthorized stay determination section which infers unauthorized stay to determine a watching state. In this case, an outer AIR sensor is provided.

An operation of the watching state determination device 6B will be described.

The unauthorized entry determination section 13Ba determines occurrence of a combination of the manual door 2B being not fully closed and no object being detected. That is, the unauthorized entry determination section 13Ba determines that the manual door 2B is not fully closed and objects have been detected within an inner object detection area 50a and within the movable detection area 50d.

The following unauthorized entry determination process is, for example, a process of inferring that, when an occupant of a building enters the building, a person who intentionally slips into the building together with the occupant is present.

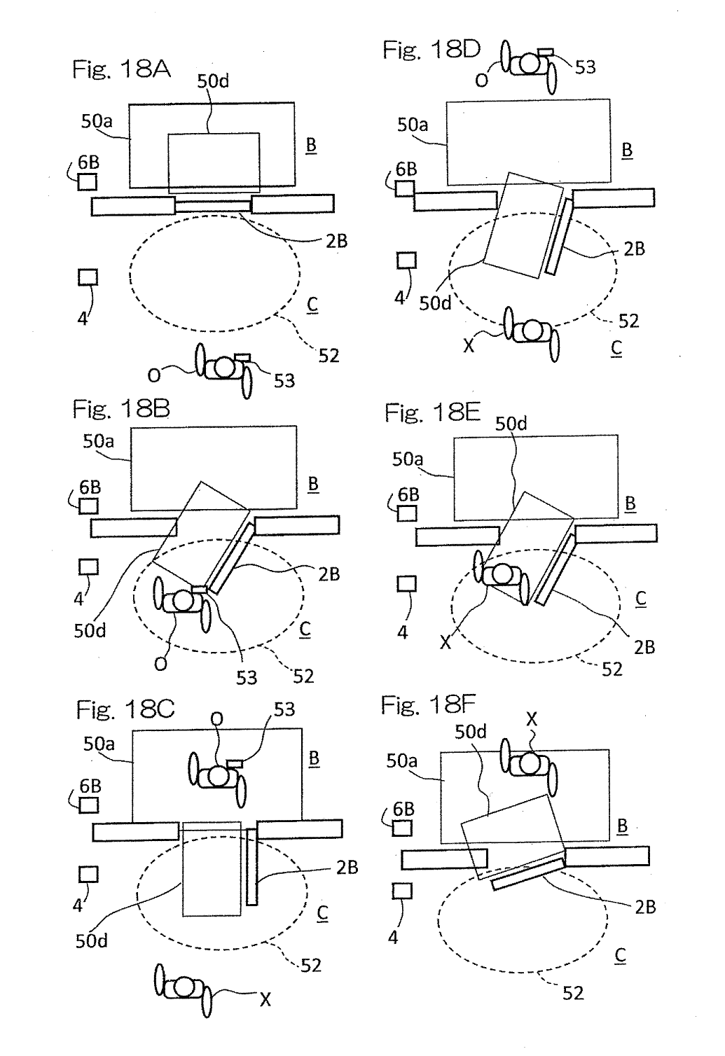

First, in FIG. 18A, the manual door 2B is fully closed, and an occupant O enters the windbreak chamber C. When the occupant O enters the authentication area 52, that is, the RFID authentication area 52, as shown in FIG. 18B, the authentication device 4 recognizes an RFID tag 53 incorporated in a security card carried by the occupant O, and outputs an authentication signal.

The authentication determination module 15 (FIG. 17) that has received this signal outputs the permission instruction signal to the electric lock 7B so as to permit opening of the manual door 2B, if having authenticated the RFID tag recognized by the recognition device 4. Thus, the occupant O can open the manual door 2B. As shown in FIG. 18C, an unauthorized person X observes that the manual door 2B is opened by the occupant O. The unauthorized person X tries to pass through the manual door 2B that has been opened, to enter the restricted zone B. When the occupant O comes out of the movable detection area 50d and enters the inner detection area 50a, the manual door 2B is about to close by means of a door closer which is not shown.

At the time point when the occupant O comes out of the inner detection area 50a as shown in FIG. 18D, the manual door 2B is shifting from an opened position to a closed position and is not fully closed. Thus, the unauthorized entry determination section 13Ba (FIG. 17) determines that the manual door 2B is not fully closed and no object has been detected.

When the unauthorized person X enters the movable detection area 50d as shown in FIG. 18E, since the unauthorized entry determination section 13Ba (FIG. 17) recognizes the degree of opening of the manual door 2B, the unauthorized entry determination section 13Ba determines that an outer object detection signal has been received. In particular, while the manual door 2B is about to close, a portion of the movable detection area 50d is included in the windbreak chamber C. Even so, the degree of opening of the manual door 2B can be recognized based on detection information from the door-fixed AIR sensor 5d, and thus it is possible to determine that the unauthorized person X has entered the inner detection area 50a in the restricted zone B from the portion of the movable detection area 50d included in the windbreak chamber C.

When the unauthorized person X enters the inner detection area 50a as shown in FIG. 18F, the unauthorized entry determination section 13Ba (FIG. 17) determines that an inner object detection signal has been received. As described above, after the unauthorized entry determination section 13Ba (FIG. 17) determines that the manual door 2B is not fully closed and no object has been detected by the AIR sensors 5a and 5d, if an object is detected within the portion of the movable detection area 50d that is included in the windbreak chamber C (that is, it is determined that the outer object detection signal has been received) and then the inner object detection signal is received, unauthorized entry is inferred. Then, when unauthorized entry is inferred, the unauthorized entry determination section 13Ba (FIG. 17) determines that it is currently in a watching state, and outputs a warning signal to the warning device 8 (FIG. 2). The reason why such a determination is made is that when the manual door 2B is not fully closed, there is no authenticated RFID tag in the authentication area 52, and an object is detected within the inner object detection area 50a, it is inferred that the detected object has passed through the opened manual door 2B to enter the restricted zone B without authority.

In this embodiment, similarly to the first embodiment, the unauthorized entry determination process is performed also when the occupant O comes out of the restricted zone B.

In this embodiment, similarly to the first embodiment, an unauthorized stay determination process may also be provided. A requirement for the unauthorized stay determination is that the manual door 2B is fully closed, an object is detected at the outer side, and an authentication signal is not received.

In this embodiment, various measures are taken in order to prevent the object detection device 5 from erroneously detecting the manual swing door 2B as an object. For example, a manual door is provided in a passage having a width, especially a width which is a little larger than the width of the door 2B, and an object detection area 50c is formed so as not to include a path of a door. In this case, the object detection area 50c is away from the door 2B, but movement of a person is restricted by the passage, and thus the person certainly crosses the object detection area.

As described above, with the system according to the embodiments, a state related to the gate 2 (2A, 2B) can be accurately inferred and handled as appropriate. In addition, the full closing detection device 3, the authentication device 4, the object detection device 5, the starting devices 21 and 22, and the like, which are included in the system in the embodiments, may be components used in a conventional automatic door system, and thus the system has a simple configuration but is able to determine a watching state.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

As examples of the gate, the automatic slide door, the automatic shutter, and the manual swing door have been taken, but the gate is not limited to them. For example, the gate may be a manual slide door or an automatic swing door.

The object detection device includes the AIR sensors, but may include any sensor that is capable of detecting presence of an object. For example, a PIR sensor or a microwave sensor may be included.

### REFERENCE NUMERALS

1 . . . system for gate
2 . . . gate
3 . . . full closing detection device
4 . . . access device
5 . . . object detection device
5a, 5b . . . AIR sensor
6 . . . watching state determination device
13 . . . watching state determination module
B, C . . . zone

What is claimed is:

1. A device for determining an alert condition derived from a state of a gate provided between two zones, the gate being movable between an closed position and an opened position, the device being included in a system for the gate, wherein
the system includes:
an access device accessed by an object which tries to enter a predetermined one or either one of the two zones, the gate being moved to the opened position or moving the gate to the opened position being permitted at least after the access device is accessed;
a full closing detection device configured to detect full closing of the gate, in which the gate is in the closed position;
an object detection device including at least one object detection sensor configured to detect an object in a detection area which is near the gate and within at least one of the two zones; and
the device for determining the alert condition,
the device for determining the alert condition is configured to be connected to the full closing detection device and the object detection device, and
the device for determining the alert condition comprises an alert condition determination module configured to determine the alert condition after a predetermined combination of: full-closing detection or non-detection by the full closing detection device; and object detection or non-detection by the object detection device occurs.

2. The device as claimed in claim 1, wherein
the two zones include a first restricted zone to which entry is restricted and which the object tries to enter, and a second zone, respectively,
the access device includes an authentication device configured to determine whether the object which tries to enter the first zone has authority, and
only when the authentication device determines that the object has authority, the gate is moved to the opened position or moving the gate to the opened position is permitted.

3. The device as claimed in claim 2, wherein the object detection device includes two object detection sensors configured to detect objects in two detection areas which are near the gate and within the two zones, respectively.

4. The device as claimed in claim 3, wherein
the predetermined combination is that the gate is not in the closed position and no object is detected within any of the two detection areas, and
after the combination occurs, if an object which does not have authority is detected in the detection area within the second zone and then an object is detected in the detection area within the first zone, the alert condition determination module infers unauthorized entry to judge the alert condition.

5. The device as claimed in claim 2, wherein
the predetermined combination is that the gate is in the closed position and an object is detected in the detection area within the second zone, and
if the combination continues for a predetermined stay time, the alert condition determination module infers unauthorized stay to judge the alert condition.

6. The device as claimed in claim 1, wherein
the predetermined combination is that the gate is in the closed position and an object is detected in the detection area within at least one of the two zones, and
when the combination occurs, the alert condition determination module infers a possibility of danger to judge the alert condition.

7. The device as claimed in claim 1, wherein the gate includes an automatic door or an automatic shutter.

8. The device as claimed in claim 3, wherein while the gate moves from the opened position to the closed position, if at least one of the two object detection sensors detects an object in the associated detection area, the moving direction of the gate is changed so that the gate moves to the opened position.

9. The system for the gate, the system comprising the device for determining an alert condition as claimed in claim 1.

10. The device as claimed in claim 1, wherein the object detection device includes two object detection sensors configured to detect objects in two detection areas which are near the gate and within the two zones, respectively.
